(19) United States
(12) Patent Application Publication
(10) Pub. No.: US 2025/0095297 A1
(43) Pub. Date: Mar. 20, 2025

(54) SYSTEMS AND METHODS OF EVENT AUDITING FOR ACTIVE DENIAL SECURITY SYSTEMS

(71) Applicant: MYTI, Inc., Delray Beach, FL (US)

(72) Inventors: Steven W. Goldstein, Delray Beach, FL (US); Eric Browy, Meridian, ID (US)

(21) Appl. No.: 18/884,971

(22) Filed: Sep. 13, 2024

Related U.S. Application Data
(60) Provisional application No. 63/538,420, filed on Sep. 14, 2023.

(51) Int. Cl. G06T 17/20; G06T 7/11

(52) U.S. Cl. CPC G06T 17/20; G06T 7/11

(57) ABSTRACT

A method that includes (a) receiving a set of dynamic parameters from sensors that record activities that occur at a security facility, wherein the set of dynamic parameters include a feature for input into a machine learning model, (b) segmenting, by a trained machine learning model, the feature to create a tag associated with each segmented feature, and (c) generating a scene that includes the set of dynamic parameters and the tag, wherein the scene is a file that can be presented on a display.

### REFERENCE TO RELATED PATENT APPLICATION

The present application claims benefit of U.S. Provisional Application No. 63/538,420 filed on Sep. 14, 2023. The content of the above document is incorporated herein by reference in its entirety.

### TECHNICAL FIELD

The disclosure is meant to be used in the physical security field, implementing elements from Machine Learning, Spatial Mapping, 3D Rendering, Security Cameras and Systems, Distributed Computation, Edge Processing, UAS, Non-Lethal technology, Motion Control, and Computer Vision.

### BACKGROUND

In the advent of modern physical security, based in remote monitoring and lower volumes of new hires there is a need for systems which controlled remotely can augment, enhance, or in some instances replace the human security guard. To this there must be many methods for the evaluation of a scene both in real time and in retrospect.

In many instances the only way to understand a scene is to analyze previously recorded video for the output of any movement or actions. In this system and using the methods disclosed herein, many different embodiments may be implemented which combine technologies and not only maintain raw footage and metadata, but semantically understand a scene to categorize and label behaviors to decrease the burden on the security professional, resulting in a reduced burden to train to more advanced levels.

### SUMMARY

Various embodiments of an auditing system used in concert with an Active Denial System (“ADS”) are feasible. One embodiment creates a system which is advantageous for a user with a known map of an environment to recreate a scene for the purpose of auditing a scenario.

The auditing system may receive a 3D map of an environment which is captured with a commercial solution to generate a 3D map of the environment. In one embodiment, the auditing system may be configured to ingest unprocessed sensor data (e.g., a raw camera feed) from multiple viewpoints and generate via photogrammetry a 3D map of the scene. In another embodiment, the auditing system may be configured to use Neural Radiance Fields (“NeRFs”) to recreate the scene. NRFs are a method to generate a 3D representation of a scene from 2D views captured by an imaging sensor. The imaging sensor may be synchronized to an Inertial Measurement Unit (“IMU”) of a mobile sensor. The 3D representation may be calculated using a combination of the 2D views to produce a 3D scene. For example. to produce the 3D views, a light intensity (e.g., a radiance) is calculated for each viewpoint (e.g., a position of a 2D view) and the neural network generates the 3D view. By using NeRFs, novel viewpoints may be observed from images that are captured by the sensor.

This 3D map of the scene may then be uploaded to a User Interface (“UI”), and this becomes the base environment which represents a digital twin of the scene captured at one moment in time. This 3D map may be updated at any given time with the correct process. Once the 3D map is obtained, the elements which fall within the mapped space may be used to audit the scene. In one embodiment, the elements within the mapped space may include location information such as weather, time of day, and/or GPS coordinates. In some embodiments, the auditing system may include environmental variables and additional dynamic parameters such as work schedules of employees, sensitive equipment or areas, privacy restrictions, OSHA violations, compliance of policies. The environmental variables may indicate behavioral information such as a person working or person approaching or crossing a threshold of safety.

An aspect of all embodiments is targeting and tagging of people who are in a scene. In some embodiments this may include information about people such as traits, location, behavior, orientation, and interactions, which may be tracked to ensure that there is not any dosage (e.g., deterrent, non-lethal deterrent, or countermeasure) given to a particular individual that is above predetermined, chosen or approved safety limits.

To accomplish this task the ADS maintains a log of the aforementioned parameters as well as the ADS assets. In some embodiments the assets of the ADS may include drones, robots, static items, IoT devices, and environmental elements. The ADS may tag and/or track the environmental elements and the assets to conduct different analysis for the user auditing the system. The tagging and tracking are used to enable the regulation and architecture of a Counter Personnel System (“CPS”).

To simplify the output of scene to usable information in an auditing environment for an ADS, one may implement embodiments which include pose-based analysis, which may look at the pose and position of a person in the systems field of view and based on that behavior create a behavioral graph on the persons intent. Another embodiment of the analytical capabilities of the system may use many forms of time-series analysis based on the change in value over time to create a graph based on time series. Following the analytical recording of information from an ADS it is possible to conduct statistical inference to include Analysis of Variance (“ANOVA”), skew, kurtosis, and/or standard deviations of behavior.

With all these subsystems in place in many configurations and embodiments, the system may provide time-sliced situational awareness of a physical security system providing active denial to a protected area. This ADS is used to prevent people from entering areas in which they are not supposed to be in as described in U.S. Provisional Application No. 63/538,420. The auditing system is a method to generate sharable and usable content to review a scene for the overall value of the end user, legal bodies, law enforcement, and any other entity that can use this data to make actionable decisions.

### BRIEF DESCRIPTION OF DRAWINGS

The present disclosure is further described in detail below with reference to the accompanying drawings and specific embodiments in which like references indicate similar elements.

FIG. 1 illustrates parameters which will be tracked in one or more embodiments of the system and methods for auditing for an ADS as embodied in one configuration according to this disclosure.

FIG. 2 illustrates an example of sample information maintained on-premises and in a cloud computation system according to an embodiment of this disclosure.

FIG. 3 illustrates an example embodiment of the intent to audit a scene to include the parameters described according to the disclosure.

FIG. 4 illustrates the scene using an interface used which incorporates a render engine and overlay of a scene according to an embodiment of this disclosure.

FIG. 5 illustrates a computing environment that can execute active denial system according to aspects of the present disclosure.

### DETAILED DESCRIPTION

This disclosure is now described more fully with reference to various figures that are referenced above, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans. All identically numbered reference characters correspond to each other so that a duplicative description of each reference character in the drawings may be omitted.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the invention.

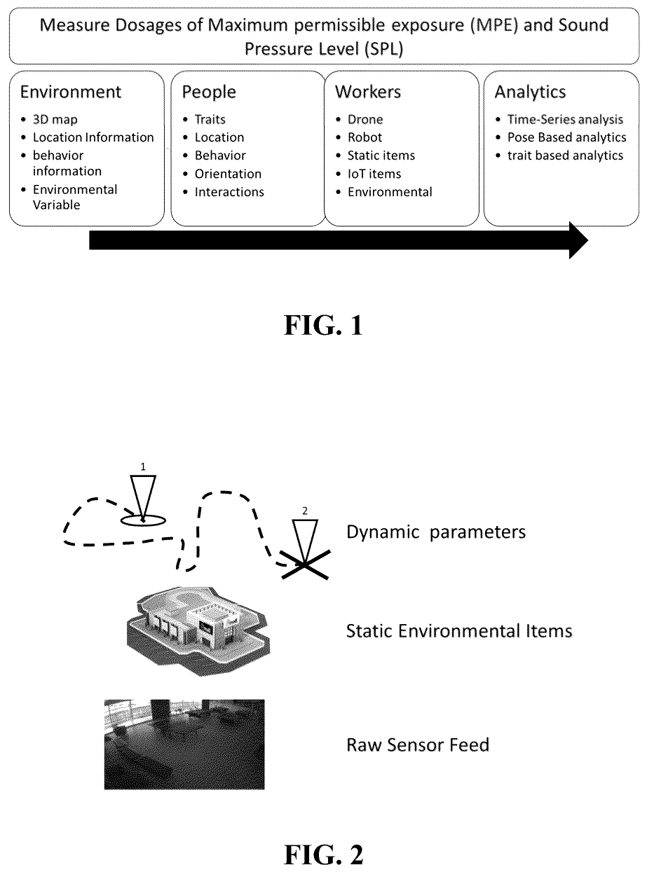

FIG. 1 illustrates a description of parameters which may be tracked in one or more embodiments of the system and methods for auditing for an active denial system. For any given embodiment, these parameters may be used as baseline set of parameters. The set of parameters may be customized to include any other information from a scene to create an audit of an event. The auditing system may have many functions with many possible outputs and it is important that the policies set forth in the policy engine or any other configuration track the values of which there is value within a specific embodiment. The parameters illustrated in FIG. 1 may be accessible to various users of the active denial system. For instance, the set of parameters may be stored in cloud storage, a database, or other component of the active denial system.

FIG. 2 illustrates sample information maintained on-premises and in a cloud computation system according to an embodiment of this disclosure. FIG. 2 illustrates the dynamic parameters that includes all dynamically tracked information of the active denial system. For some embodiments, the dynamically tracked information includes locations of tracked people, dynamic behavior of tracked objects, positions and/or status information of Unmanned semi and fully autonomous systems. However, these are examples and any other parameter that changes throughout the time of an audit can be included in the dynamically tracked information.

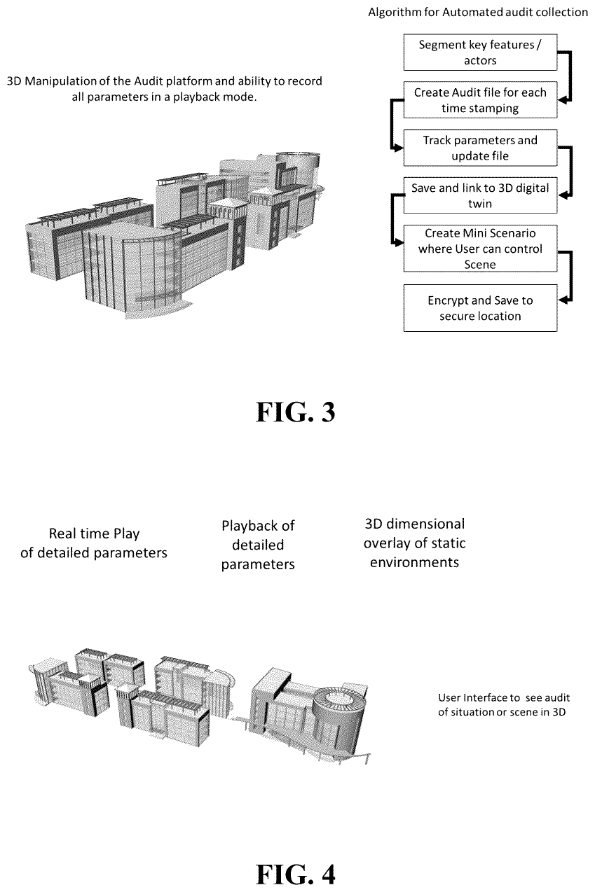

FIG. 3 illustrates an example method of auditing a scene to include the dynamic parameters according to embodiments of the disclosure. The method includes an example process to audit the scene. In some embodiments, the process to audit may use embedded or distributed CV/AI/ML to segment key features in a scene. The segmentation of key features may create a tag associated with each segmented feature. In one embodiment, this tag may be associated with a person (e.g., a criminal) that is acting against the law or signage posted (e.g., by law, internal policies) in the area being secured with an active denial system. To recreate a scene in 2D and 3D, a baseline configuration file may be generated during the initial installation and calibration of the system. The file may be generated with null values that can store all the types of data generated by the active denial system. The data generated by the ADS may be collected through a message queuing telemetry transport (MQTT) or similar protocol and stored as a protocol buffer (e.g., protobuf), a JavaScript Object Notation (JSON) file, or other storage format.

The file may be updated with the dynamic variables in a time sequential series. The dynamic variables are captured live from the scene and at specific intervals of time. The ADS may create a copy and apply a timestamp to the copy of the file. After selecting the file, the ADS may generate a miniature environment to present the data in combination with an associated digital 3D reconstruction of the data (e.g., the dynamic variables localized within the instance). A render engine of the CPS may be configured to read data stored in the configuration file and allow for playback of a scene.

FIG. 4 illustrates an embodiment of the ability to replay the scene with the dynamic parameters. The scene may be presented in a video that is stored by the ADS. The ADS may provide a copy of the video to external computing terminals such that the copy of the video can be shared independently of this application (e.g., external to the active denial system). To provide the copy, the ADS may receive a set of options from a user operating a user interface. For example, the set of options may manipulate a presentation of the video such that various dynamic parameters are visible or hidden, and/or a viewing angle is changed such that areas of interest can be presented in the user interface.

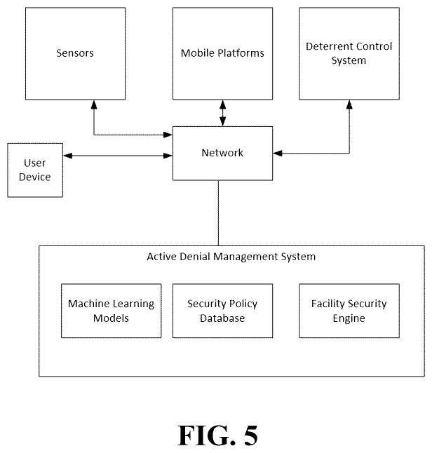

FIG. 5 illustrates a computing environment that may execute an ADS according to aspects of the present disclosure. For example, FIG. 5 depicts an ADS that is communicatively coupled (e.g., by wired or wireless networking infrastructure) to a network (e.g., a LAN, a WAN, a satellite network, a cellular network) to communicate with user devices, sensors, mobile platforms, and/or a deterrent control system. The network may be a physical network, a wireless communication network, or other suitable means of communication. In some examples, multiple networks may be used to communicate with each type of device (e.g., a first network for user devices, a second network for sensors, etc.). The ADS may include a machine learning model, a security policy database, and a facility security engine. Any of the machine learning model, security policy database (e.g., relational), or the facility security engine (e.g., a task-dedicated executable logic that can be started, stopped, or paused) may be executed as a logical component of the ADS or as a cloud-based or network-based component. The ADS may be executable as a single computing device, or as a distributed system across a network of computing devices. The machine learning models may perform operations as described above and may be convolutional neural networks, deep learning networks, generative-adversarial networks, or other machine learning models. The security policy database may include a predetermined set of policies, such as a set of conditions for activating the deterrent control system or components thereof.

The security policy database may also include another set of conditions for activating or controlling the mobile platforms. For example, the security policy database may include a set of activities that are prohibited at the security facility. Each activity of the set of activities may be associated with an escalation process including a set of authorized deterrents and a sequence of the authorized deterrents. In some instances, the security policy database includes various sets of activities that if detected concurrently or within a time threshold have an additional authorization for deterrents. For example, a first activity has an associated low severity level and an authorized deterrent of a verbal warning via loudspeaker or other communication system. In another example, a combination of an arson and brandishing or possessing a weapon may have a high severity level and an authorized deterrent of an agent such as a laser sparkle, acoustic deterrent, or a chemical agent. The security policy database may further include a time delay between authorized deterrents or escalating to an additional authorized deterrent for a prohibited activity that exceeds a threshold time.

The security policy database may be a relational database, an object storage architecture such as a data lake, or a non-relational database. The facility security engine may be an executable process that generates a digital representation of the facility including, but not limited to, structures, people, animals, vehicles, mobile platforms, gates, fences, sensors, and/or deterrent mechanisms and associated control devices. In some embodiments, the computing environment may include multiple user devices, such as for security personnel, facility management personnel, or other authorized users. The user devices may control or interact with the ADS using sets of permissions associated with different groups of users. For example, the user devices may connect using a mobile application, biometric authentication, and/or the network. The ADS may control access or authentication of any user device to the network using encryption keys, virtual private network settings, token credentials, or other methods of controlling access of mobile devices to the network.

As set forth in the foregoing exemplary embodiments, the disclosure herein is focused on the ability to record and understand information within areas of interest, and be able to use it rapidly, during or after the fact depending on the embodiment to show, for example, where people were, what they were doing, what justified escalation, and thus establish a justification for using non-lethal force.

While various aspects and embodiments have been disclosed, other aspects and embodiments are contemplated. The various aspects and embodiments disclosed are for purposes of illustration and are not intended to be limiting, with the true scope and spirit being indicated by the claims in the non-provisional application claiming priority to this provisional application.

What is claimed is:

1. A method, comprising:
receiving, by a processing unit, a set of dynamic parameters from sensors that record activities that occur at a security facility, wherein the set of dynamic parameters include a feature for input into a machine learning model;
segmenting, by a trained machine learning model, the feature to create a tag associated with each segmented feature; and
generating, by the processing unit, a scene that includes the set of dynamic parameters and the tag, wherein the scene is a file that can be presented on a display.
